(19) United States
(12) Patent Application Publication
(10) Pub. No.: US 2017/0054742 A1
(43) Pub. Date: Feb. 23, 2017

(54) INFORMATION PROCESSING APPARATUS, INFORMATION PROCESSING METHOD, AND COMPUTER READABLE MEDIUM

(71) Applicant: MITSUBISHI ELECTRIC CORPORATION, Tokyo (JP)

(72) Inventor: Mitsuhiro MATSUMOTO, Tokyo (JP)

(73) Assignee: MITSUBISHI ELECTRIC CORPORATION, Tokyo (JP)

(21) Appl. No.: 15/106,177

(22) PCT Filed: Dec. 27, 2013
(86) PCT No.: PCT/JP2013/085193

§ 371 Date: Jun. 17, 2016

(51) Int. Cl. H04L 29/06; G06F 17/30

(52) U.S. Cl. CPC H04L 63/1416; G06F 17/30864; H04L 63/1425

(57) ABSTRACT

A receiving unit (111) receives log information of a data communication that has occurred in a data processing system (106), as communication log information. An attacked terminal log information identification unit (113) retrieves, from among a plurality of pieces of processing log information being log information of data processing performed in the data processing system (106), processing log information of data processing related to the data communication, based on the communication log information. A terminal log information falsification detection unit (114) determines that processing log information being at least a part of the plurality of pieces of processing log information is falsified when the corresponding processing log information is not retrieved by the attacked terminal log information identification unit (113).

### TECHNICAL FIELD

The present invention relates to an information security technology.

### BACKGROUND ART

Patent Literature 1 discloses an infection range identification apparatus that identifies an infection range infected with malware.

The infection range identification apparatus in Patent Literature 1 identifies a file infected with the malware by using antivirus software and identifies a terminal that has accessed the identified file, thereby identifying the infection range (Patent Literature 1).

Patent Literature 2 discloses an infected path identification apparatus that identifies malware using a packet signature and also identifies an infected path using a packet transmission source/transmission destination.

Patent Literature 3 discloses a malware detection apparatus that detects malware of a latent type.

The malware detection apparatus in Patent Literature 3 grasps a characteristic of communication by the malware, thereby identifying a server apparatus that issues an instruction to an infected terminal and the infected terminal.

Patent Literature 4 discloses a file access monitoring apparatus that monitors a rewriting operation of a registry or a program, which is a characteristic operation of malware, thereby detecting infection by the malware (Patent Literature 4).

### CITATION LIST

### Patent Literature

Patent Literature 1: JP 4705961

Patent Literature 2: JP 2011-101172A

Patent Literature 3: JP 2009-110270A

Patent Literature 4: JP 2005-148814A

### SUMMARY OF INVENTION

### Technical Problem

Patent Literatures 1 to 4, however, have a problem that a targeted attack cannot be handled.

In the targeted attack, an attacker intrudes into a terminal in a data processing system and the attacker downloads malware to the intruded terminal.

Then, the attacker expands a malware infection range in the data processing system using the terminal to which the malware has been downloaded.

In order to identify the malware infection range by the targeted attack as mentioned above, it is necessary to analyze log information of the terminal to track activity of the attacker after intrusion into the terminal.

However, the attacker may falsify the log information of the terminal in order to conceal the activity of the attacker.

If the attacker falsifies the log information of the terminal, the activity of the attacker cannot be tracked even if log information after the falsification is analyzed.

However, if falsification of the terminal log can be identified, infection of the terminal can be identified.

As described above, in order to identify the malware infection range, it is extremely important to determine whether the log information is falsified.

The present invention has been conceived in view of the circumstances as described above. It is an object of the present invention to obtain a configuration that determines whether log information is falsified.

### Solution to Problem

An information processing apparatus according to the present invention may include:

a receiving unit to receive log information of a data communication that has occurred in a data processing system, as communication log information;

a log information retrieval unit to retrieve, from among a plurality of pieces of processing log information being log information of data processing performed in the data processing system, processing log information of data processing related to the data communication, based on the communication log information; and

a falsification determination unit to determine that processing log information being at least a part of the plurality of pieces of processing log information is falsified when the corresponding processing log information is not retrieved by the log information retrieval unit.

### Advantageous Effects of Invention

According to the present invention, falsification of the processing information being at least the part of the plurality of pieces of processing log information may be determined.

### BRIEF DESCRIPTION OF DRAWINGS

FIG. 1 is a diagram illustrating a configuration example of a system according to Embodiment 1.

FIG. 2 is a flowchart diagram illustrating an operation example of an infection range identification apparatus according to Embodiment 1.

FIG. 3 is a diagram illustrating a configuration example of a network according to Embodiment 1.

FIG. 4 is a table illustrating an example of attack scenario detection information according to Embodiment 1.

FIG. 5 is a table illustrating an example of terminal log information (process log information) according to Embodiment 1.

FIG. 6 is a table illustrating an example of attacked terminal log information (process log information) according to Embodiment 1.

FIG. 7 is a table illustrating an example of terminal log information (access log information) according to Embodiment 1.

FIG. 8 is a table illustrating an example of attacked terminal log information (access log information) according to Embodiment 1.

FIG. 9 is a table illustrating an example of communication log information according to Embodiment 1.

FIG. 10 is a table illustrating an example of attack communication log information according to Embodiment 1.

FIG. 11 is a diagram illustrating an example of a request according to Embodiment 1.

FIG. 12 is a diagram illustrating an example of a request according to Embodiment 1.

FIG. 13 is a table illustrating an example of terminal infection information according to Embodiment 1.

FIG. 14 is a diagram illustrating an example of data flows of the infection range identification apparatus according to Embodiment 1.

FIG. 15 is a diagram illustrating an example of data flows of the infection range identification apparatus according to Embodiment 1.

FIG. 16 is a table illustrating an example of infection activity terminal log information (process log information) according to Embodiment 1.

FIG. 17 is a table illustrating an example of infection activity terminal log information (access log information) according to Embodiment 1.

FIG. 18 is a table illustrating an example of infection activity communication log information according to Embodiment 1.

FIG. 19 is a table illustrating an example of a port number list according to Embodiment 1.

FIG. 20 is a diagram illustrating an example of a request according to Embodiment 1.

FIG. 21 is a diagram illustrating an example of a request according to Embodiment 1.

FIG. 22 is a diagram illustrating an example of a request according to Embodiment 1.

FIG. 23 is a diagram illustrating a hardware configuration example of the infection range identification apparatus according to Embodiments 1 to 4.

### DESCRIPTION OF EMBODIMENTS

### Embodiment 1

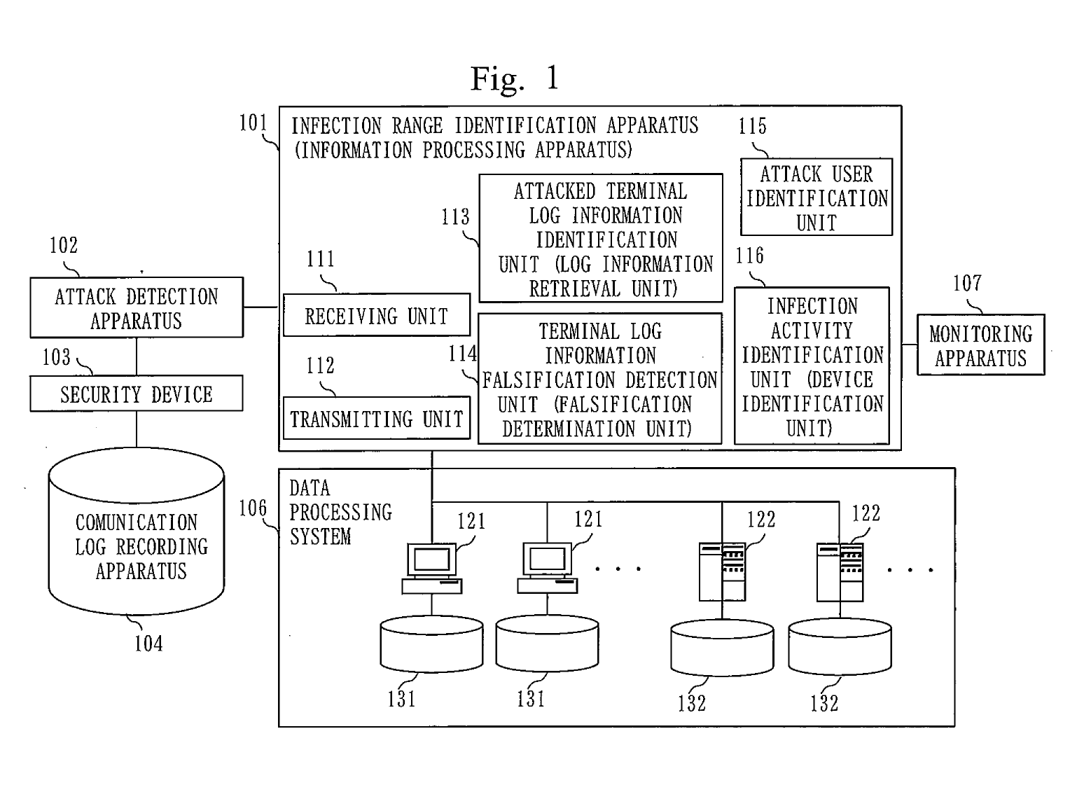

FIG. 1 illustrates a configuration example of a system including an infection range identification apparatus 101 according to this embodiment.

The infection range identification apparatus 101 checks whether log information recorded in a data processing system 106 is falsified.

The infection range identification apparatus 101 identifies a malware infection range.

The infection range identification apparatus 101 is an example of an information processing apparatus.

A security device 103 records each piece of communication log information in a communication log recording apparatus 104.

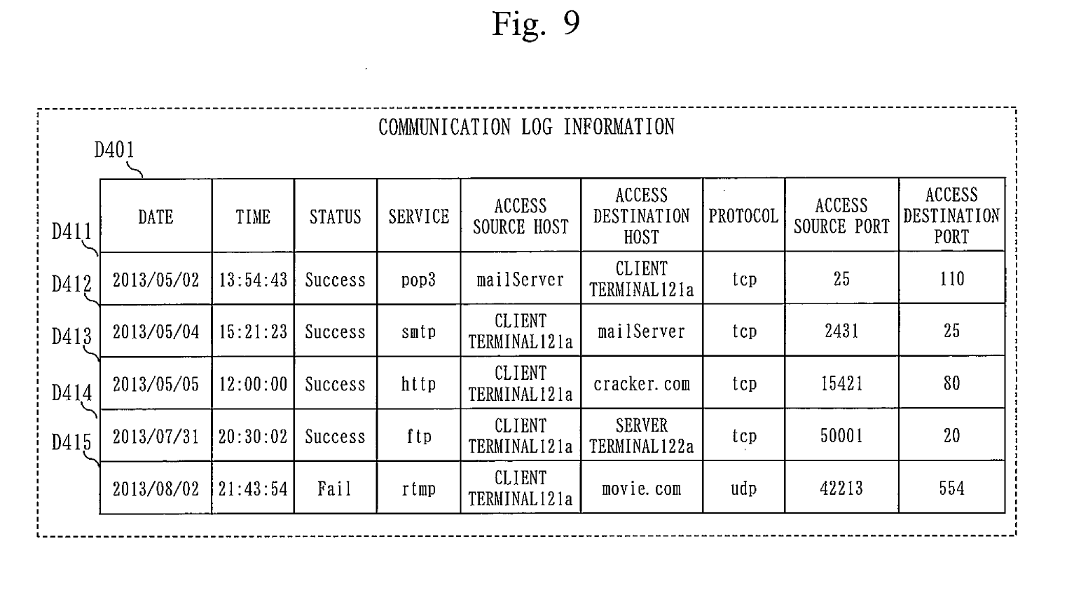

The communication log recording apparatus 104 records the communication log information in a format illustrated in FIG. 9, for example.

Communication attribute values indicating attributes of each data communication such as a date, a time, a status, a service, an access source host, an access destination host, a protocol, an access source port, and an access destination port are described in the communication log information.

The security device 103 may be an FW (firewall), an IDS/IPS (Intrusion Detection System/Intrusion Prevention System), or a proxy server, for example.

An attack detection apparatus 102 analyzes each piece of communication log information recorded in the communication log recording apparatus 104 to detect an attack.

The attack detection apparatus 102 transmits to the infection range identification apparatus 101 the communication log information of the data communication related to the detected attack (hereinafter referred to as an attack data communication), as attack communication log information.

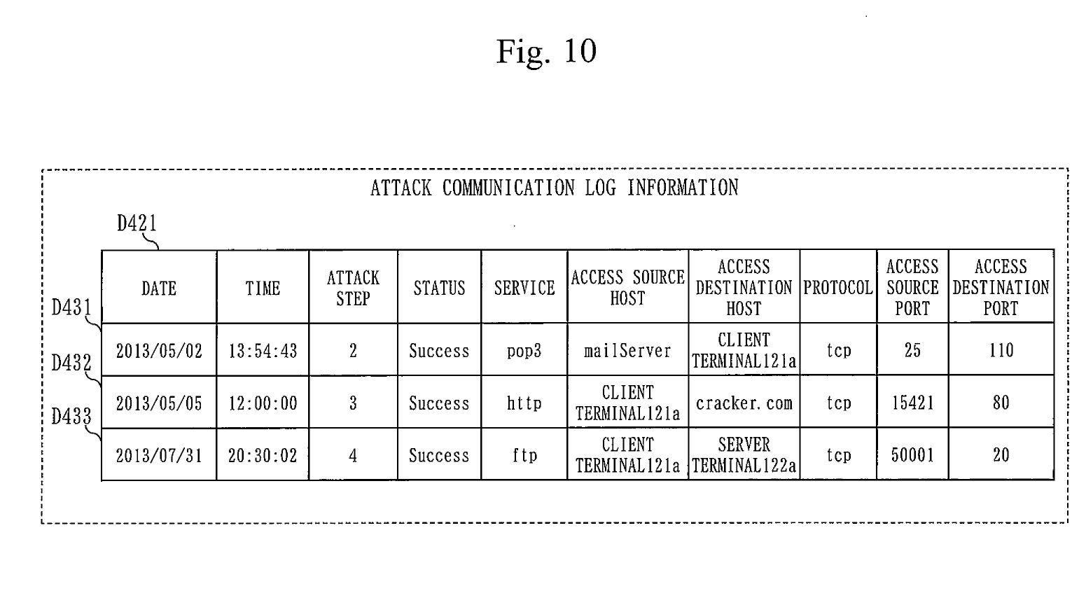

The attack detection apparatus 102 transmits the attack communication log information illustrated in FIG. 10 to the infection range identification apparatus 101, for example.

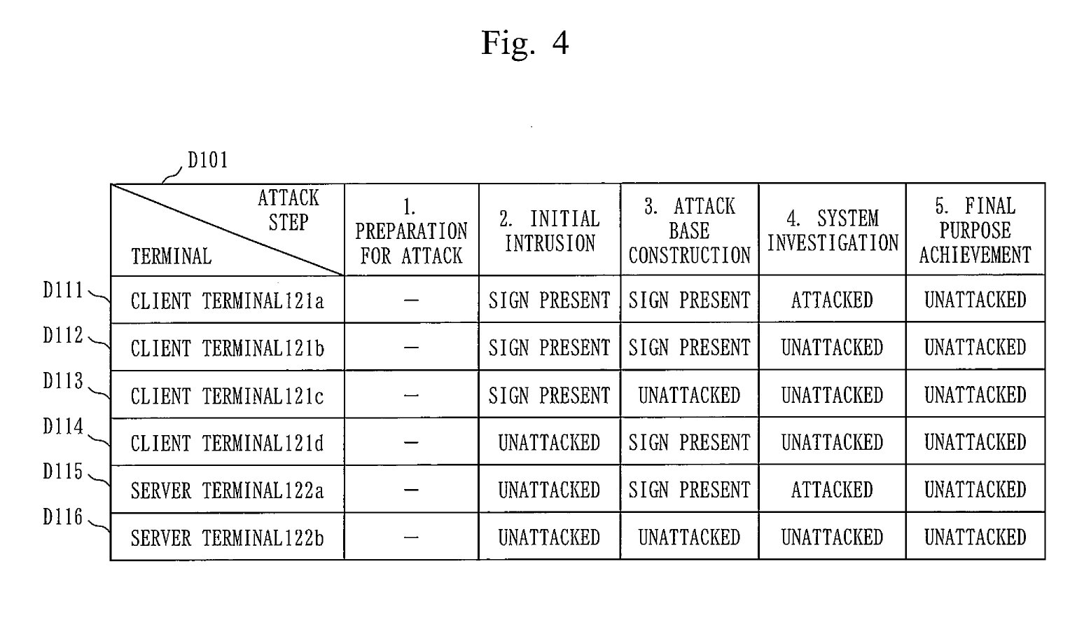

As a result of analysis on the communication log information, the attack detection apparatus 102 records, in attack scenario information illustrated in FIG. 4, a progress degree of the attack, for each client terminal 121 and for each server terminal 122.

Referring to FIG. 4, “1. Preparation for Attack” is a step where an attacker browses a Web page of an organization targeted by the attacker, a targeted mail is prepared using a brochure or the like published by the organization, or malware suited to the organization is generated.

“2. Initial Intrusion” is a step where the attacker contacts the organization targeted, using the targeted mail or the like and sends the malware to the organization.

“3. Attack Base Construction” includes a step where the malware is activated to construct an attack base necessary for information collection, and the malware, a URL, or the like attached to the targeted attack is clicked at one terminal, so that the malware infects the organization.

“4. System Investigation Step” is a step where the attacker investigates internal systems of a company from the terminal infected with the malware, and infects other terminals one after another in order to obtain more important information.

“5. Final Purpose Achievement Step” is a step where information leakage or system destruction occurs.

Referring to FIG. 4, “attacked” indicates that an attack has been detected from communication log information, “unattacked” indicates that an attack has not been detected from communication log information, and “sign present” indicates that the sign of an attack has been detected from communication log information.

FIG. 4 indicates that, with respect to a client terminal 121a, signs of attacks in attack steps 1 to 3 have been detected and an attack of attack step 4 has been detected, but an attack of attack step 5 has not been detected.

A monitoring apparatus 107 displays the malware infection range obtained by the infection range identification apparatus 101.

When the attack is detected by the attack detection apparatus 102, a network security manager may check a result of identification of the damaged range through the monitoring apparatus 107.

The data processing system 106 is configured with a plurality of the client terminals 121 and a plurality of the server terminals 122.

When there is no need for making distinction between the client terminals 121 and the server terminals 122, the client terminals 121 and the server terminals 122 are collectively referred to as terminals.

In the data processing system 106, a client terminal log recording apparatus 131 is provided for each client terminal 121, and a server terminal log recording apparatus 132 is provided for each server terminal 122.

Each client terminal 121 stores, in the client terminal log recording apparatus 131, terminal log information that is log information on data processing performed by the client terminal 121.

Each server terminal 122 stores, in the server terminal log recording apparatus 132, terminal log information that is log information on data processing performed by the server terminal 122.

The client terminal log recording apparatuses 131 and the server terminal log recording apparatuses 132 correspond to an example of a processing log information database.

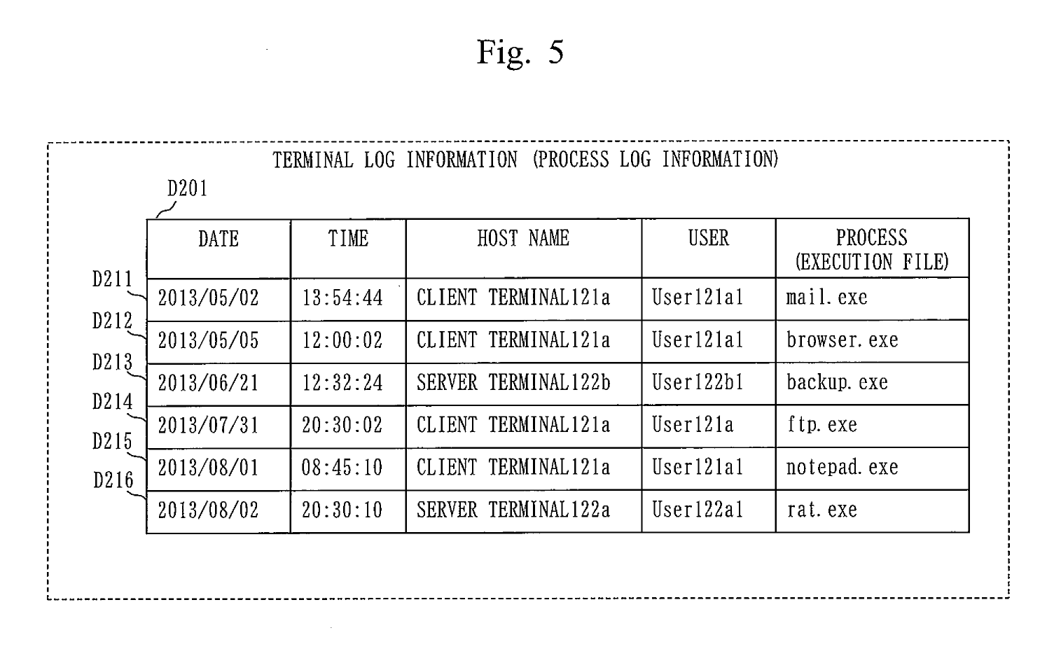

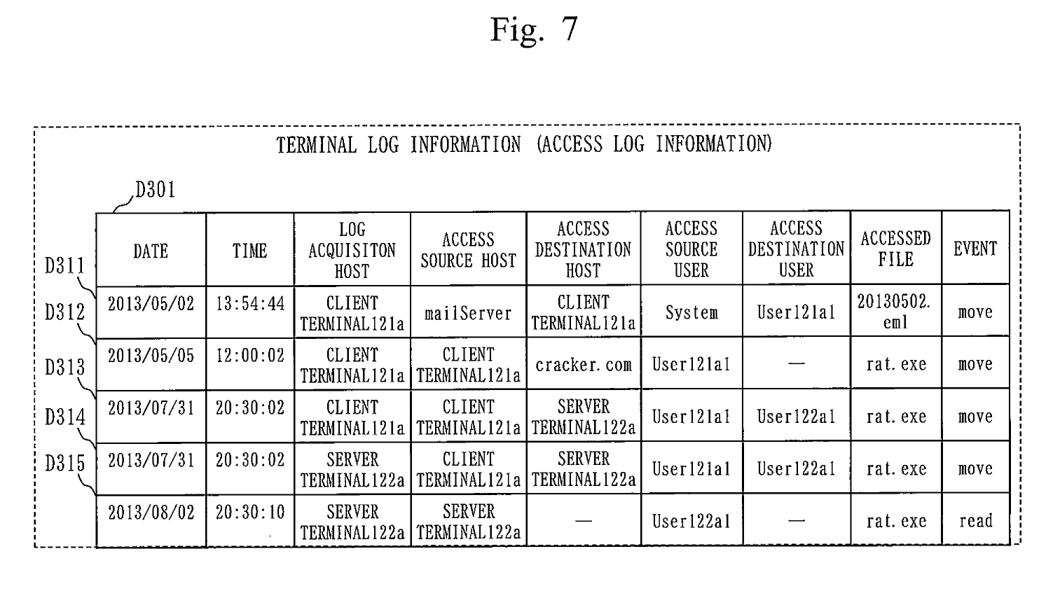

The terminal log information includes process log information illustrated in FIG. 5 and access log information illustrated in FIG. 7.

Processing attribute values indicating attributes of the data processing by each client terminal 121 or each server terminal 122 are described in each of the process log information and the access log information.

That is, the processing attribute values such as a date, a time, a host name, a user (account), and a process (execution file) are described in the process log information, as illustrated in FIG. 5.

The processing attribute values such as a date, a time, an access source host, an access destination host, an access source user, an access destination user, an accessed file, and an event are described in the access log information, as illustrated in FIG. 7.

Hereinafter, the process log information will also be written as terminal log information (process log information), and the access log information will also be written as terminal log information (access log information).

When there is no need for making distinction between the terminal log information (process log information) and the terminal log information (access log information), both of them will be collectively referred to as terminal log information.

The terminal log information (process log information) and the terminal log information (access log information) correspond to an example of processing log information.

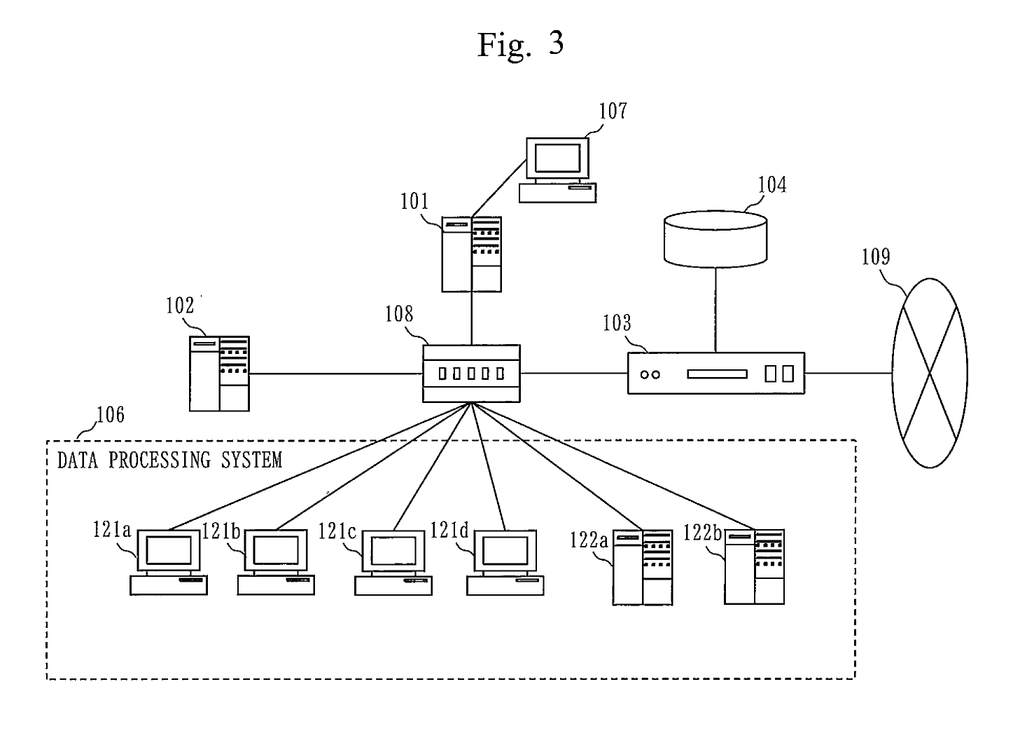

Each element illustrated in FIG. 1 is connected as illustrated in FIG. 3, for example.

Referring to FIG. 3, a switch 108 connects each of the client terminals 121 and the server terminals 122 in the data processing system 106 to the infection range identification apparatus 101, the attack detection apparatus 102, and the security device 103.

The security device 103 is connected to the Internet 109, and relays a data communication between the Internet 109 and each of the client terminals 121 and the server terminals 122 in the data processing system 106.

The security device 103 stores, in the communication log recording apparatus 104, communication log information on the data communication between the Internet 109 and each of the client terminals 121 and the server terminals 122.

Now, a description will be given about an internal configuration of the infection range identification apparatus 101 illustrated in FIG. 1.

A receiving unit 111 receives the attack communication log information from the attack detection apparatus 102.

A transmitting unit 112 transmits terminal infection information indicating the malware infection range to the monitoring apparatus 107.

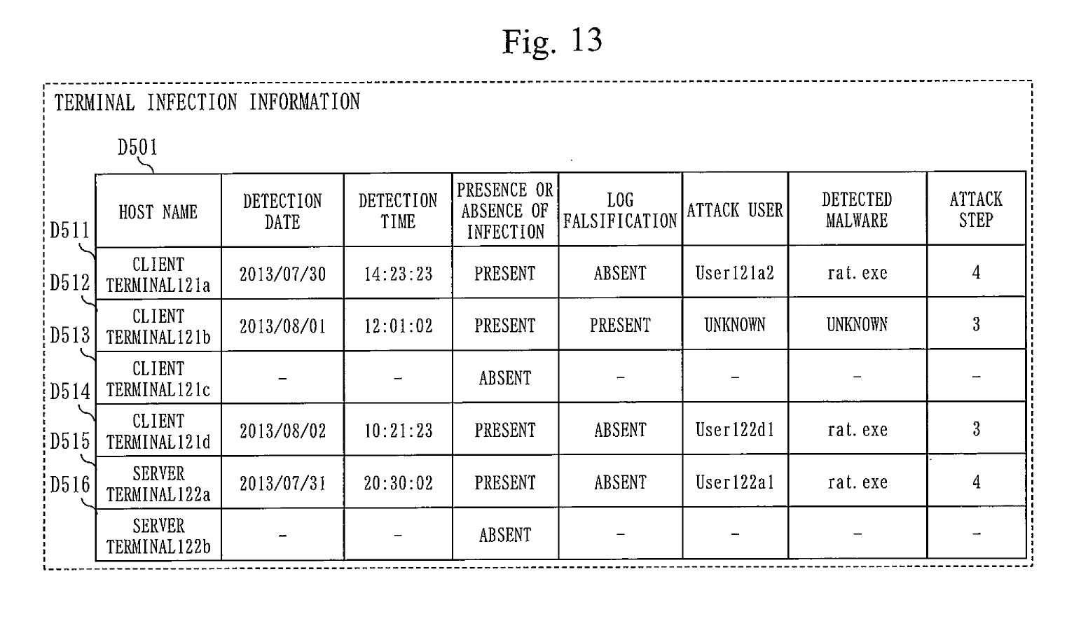

The terminal infection information is information illustrated in FIG. 13, for example.

A date and a time at which malware infection or log falsification has been detected, presence or absence of the malware infection, presence or absence of the log falsification, an attack user, detected malware, and one of the attack steps (attack steps in FIG. 4) are indicated in the terminal infection information.

Based on the attack communication log information received by the receiving unit 111, an attacked terminal log information identification unit 113 retrieves the terminal log information on the data processing related to the attack data communication, from among the terminal log information (process log information) and the terminal log information (access log information) in the client terminal log recording apparatus 131 and the server terminal log recording apparatus 132.

The terminal log information (process log information) retrieved by the attacked terminal log information identification unit 113 as the terminal log information related to the attack data communication is referred to as attacked terminal log information (process log information).

The terminal log information (access log information) retrieved by the attacked terminal log information identification unit 113 as the terminal log information related to the attack data communication is referred to as attacked terminal log information (access log information).

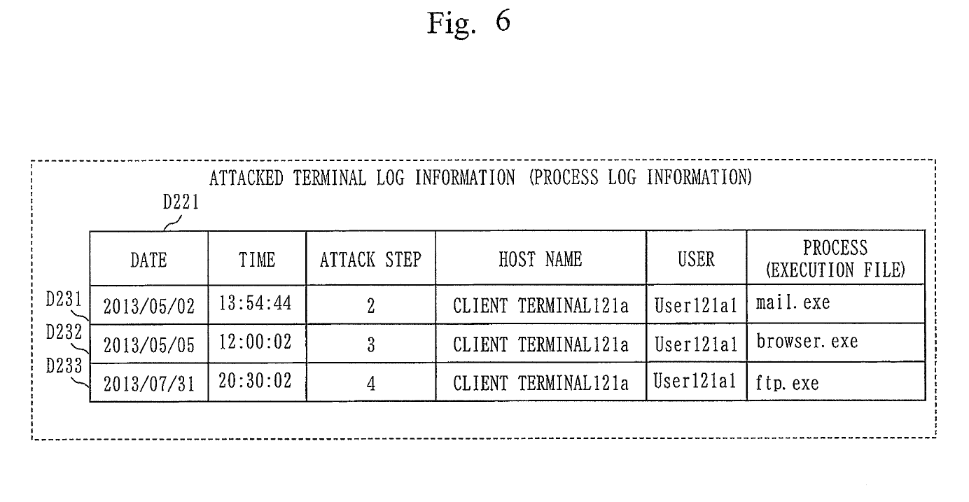

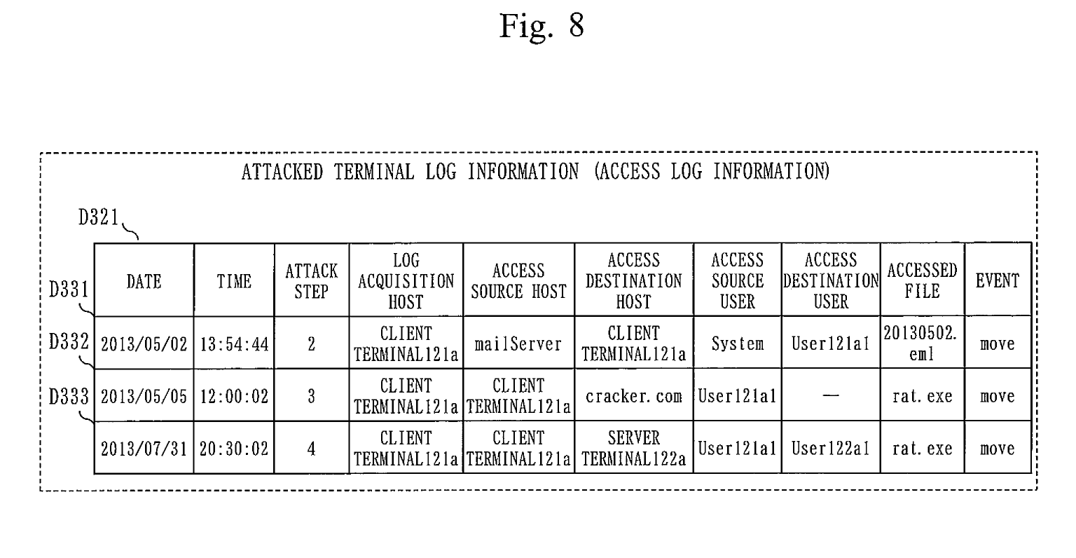

To take an example, the attacked terminal log information identification unit 113 retrieves the attacked terminal log information (process log information) illustrated in FIG. 6 and retrieves the attacked terminal log information (access log information) illustrated in FIG. 8.

When there is no need for making distinction between the attacked terminal log information (process log information) and the attacked terminal log information (access log information), both of them are collectively referred to as attacked terminal log information.

The attacked terminal log information identification unit 113 corresponds to an example of a log information retrieval unit.

If the attacked terminal log information is not retrieved by the attacked terminal log information identification unit 113, a terminal log information falsification detection unit 114 determines that the terminal log information is falsified.

More specifically, the terminal log information falsification detection unit 114 determines that the terminal log information of the client terminal 121 or the server terminal 122 notified by the attack communication log information is falsified.

When the attacker intrudes into one of the terminals using the attack data communication, data processing such as malware downloading is executed at the terminal. Therefore, a history of such data processing usually remains in the terminal log information.

Accordingly, if the terminal log information is not falsified, the terminal log information describing the data processing derived from the attack data communication is supposed to be retrieved, as the attacked terminal log information.

If the attacked terminal log information is not retrieved, it may be inferred that the attacker has falsified the terminal log information in order to conceal the action.

Therefore, if the attacked terminal log information is not retrieved by the attacked terminal log information identification unit 113, the terminal log information falsification detection unit 114 determines that the terminal log information has been falsified.

Further, if the attacked terminal log information is not retrieved by the attacked terminal log information identification unit 113, the terminal log information falsification detection unit 114 determines that the client terminal 121 or the server terminal 122 notified by the attack communication log information is infected with the malware.

Assume, for example, a case where, when the receiving unit 111 received the attack communication log information in FIG. 10 and the attacked terminal log information identification unit 113 searched for the terminal log information based on the attack communication log information in FIG. 10, the attacked terminal log information identification unit 113 could not retrieve the corresponding attack log information.

In this case, the terminal log information falsification detection unit 114 determines that the terminal log information of the client terminal 121a notified by the attack communication log information is falsified and that the client terminal 121a is infected with the malware.

The terminal log information falsification detection unit 114 corresponds to an example of a falsification determination unit.

When it is determined by the terminal log information falsification detection unit 114 that the terminal log information is not falsified, an attack user identification unit 115 identifies the user (attack user) involved in all attack phases, and transmits to an infection activity identification unit 116 attack user information describing the attack user.

To take an example, referring to attacked terminal log information D221 in FIG. 6 and attacked terminal log information D321 in FIG. 8, a user 121a1, who is a user of the client terminal 121a, is involved in all of attack steps 2, 3, and 4 (attack step 1 is not included in the attack steps because attack step 1 does not remain in the logs), and is a user involved in the sequence of the targeted attack.

For this reason, the attack user identification unit 115 regards the user 121a1 as the attack user.

The infection activity identification unit 116 receives the attack user information from the attack user identification unit 115 to identify a range where the attack user has executed an infection activity.

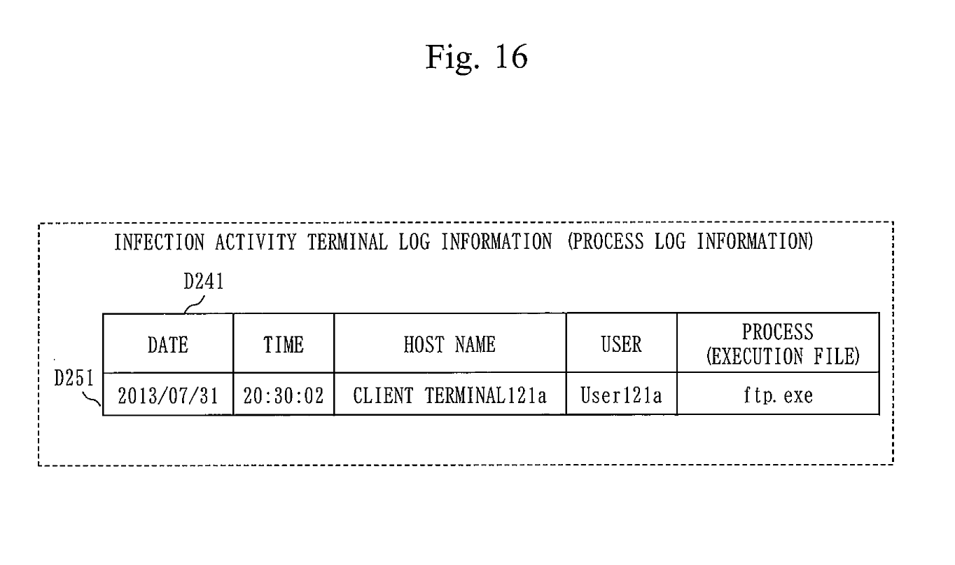

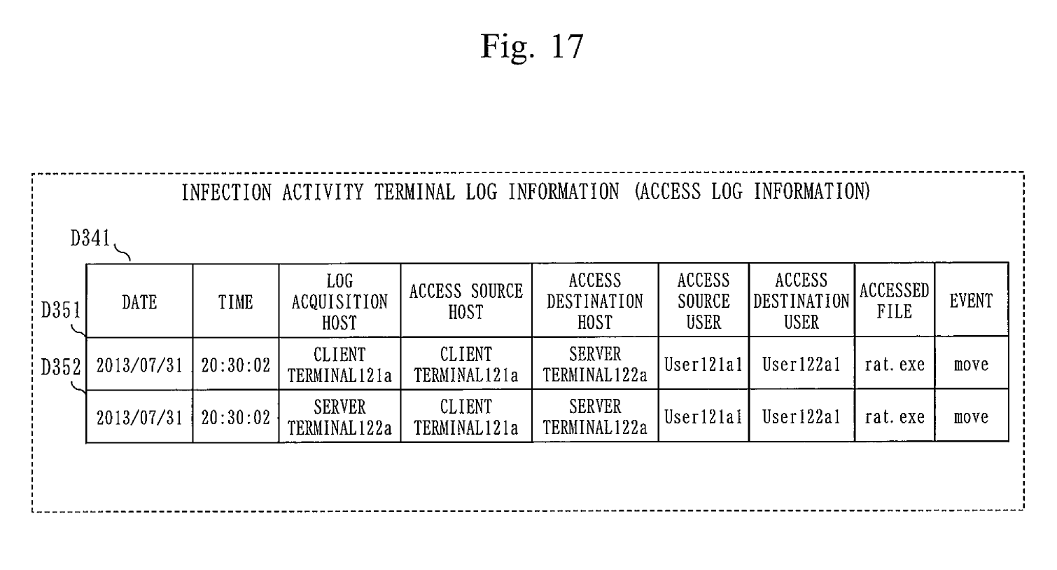

Specifically, the infection activity identification unit 116 detects transfer of a file to a different one of the terminals by the attack user, as indicated in infection activity terminal log information (process log information) D241 (where ftp.exe is a process used for the transfer of the file) in FIG. 16 and infection activity terminal log information (access log information) D341 in FIG. 17.

Further, when the file transferred is executed at a transfer destination as indicated in a record D216 in the terminal log information (process log information) in FIG. 5 or when the file transferred is accessed as a terminal file at a transfer destination as indicated in a record D352 in the infection activity terminal log information (access log information) in FIG. 17, the infection activity identification unit 116 may determine that the transfer destination has been infected.

The infection activity identification unit 116 corresponds to an example of a device identification unit.

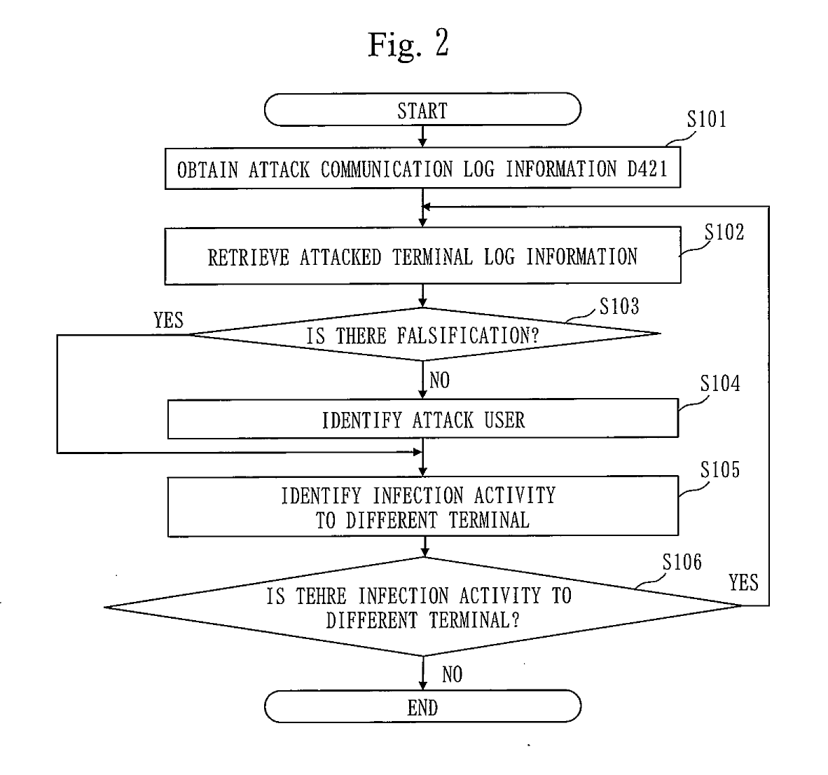

Now, an example of operations of the infection range identification apparatus 101 according to this embodiment will be described with reference to FIGS. 2, 14, and 15.

FIG. 2 is a flowchart diagram illustrating an operation example of the infection range identification apparatus 101.

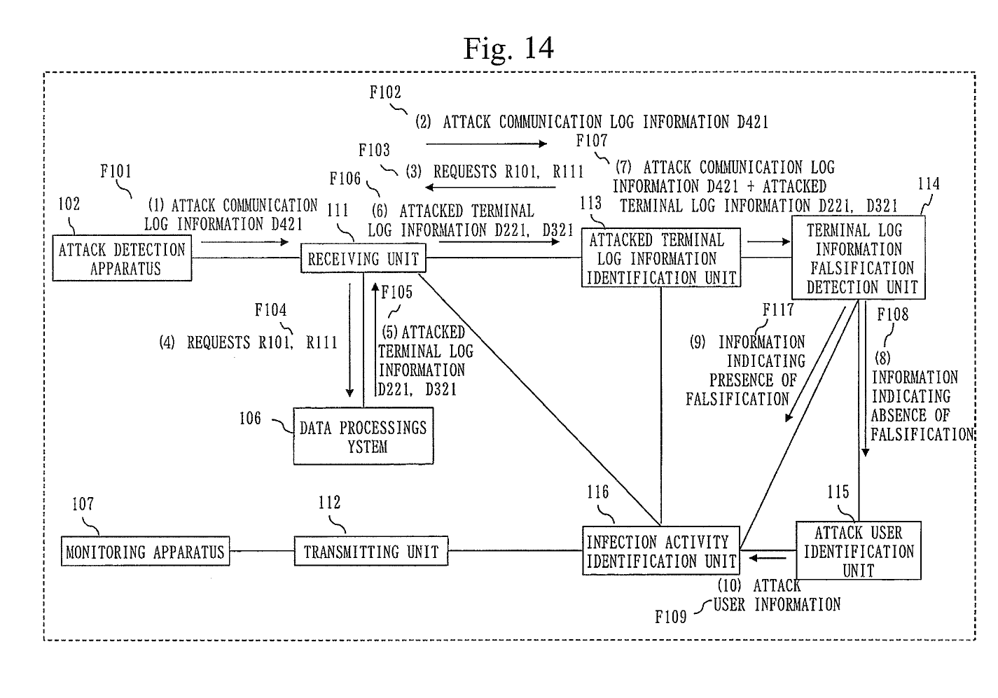

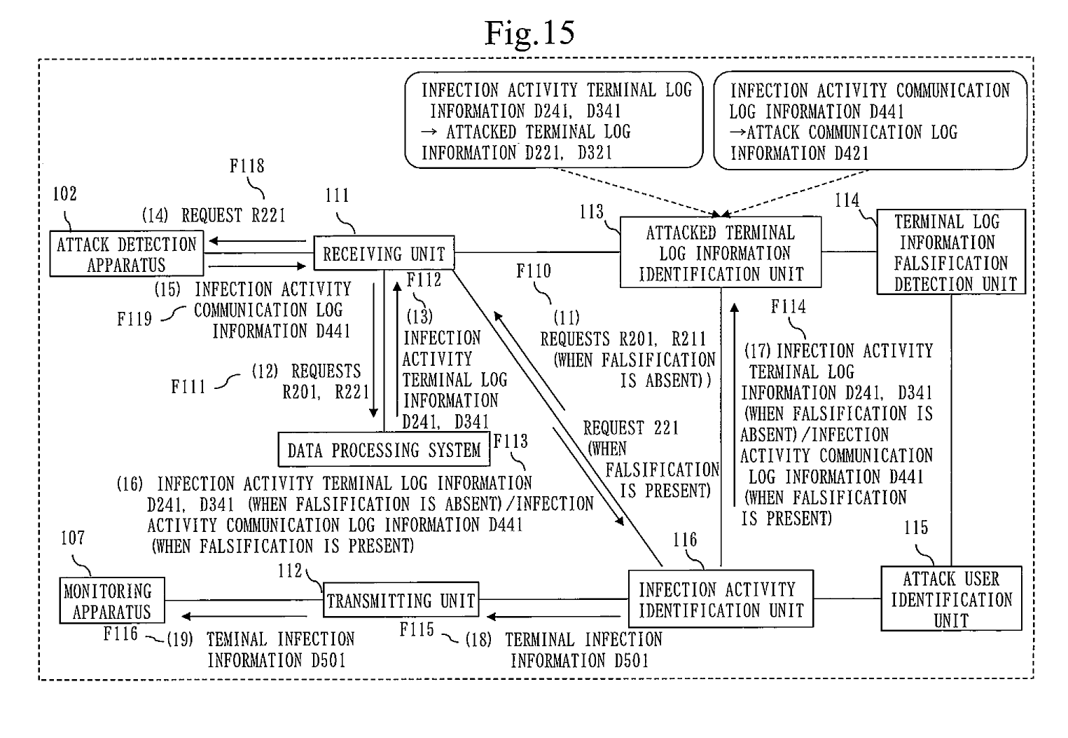

Each of FIGS. 14 and 15 illustrates data flows of the infection range identification apparatus 101.

First, the attack detection apparatus 102 detects an attack using each piece of communication log information before an infection range is identified.

The attack detection apparatus 102 extracts from the communication log recording apparatus 104 managed by the security device 103 communication log information D401 necessary for analysis, and analyzes the communication log information D401 extracted.

As a result of the analysis, the attack detection apparatus 102 identifies attack communication log information D421, and transmits the attack communication log information D421 to the infection range identification apparatus 101 (F101).

The attack detection apparatus 102 may employ any kind of attack detection method.

In S101, the receiving unit 111 of the infection range identification apparatus 101 receives the attack communication log information D421 transmitted from the attack detection apparatus 102 (F101).

The receiving unit 111 transmits the attack communication log information D421 to the attacked terminal log information identification unit 113 (F102).

A description will be given below, assuming that the receiving unit 111 has received attack communication log records D431 to 433 in FIG. 10 as the attack communication log information D421.

Herein, the attack communication log record D431 is a record in which attack step: 2 is described, the access destination host: the client terminal 121a is described, and for which “sign present” has been determined by the attack detection apparatus 102 based on a record 111 of attack scenario detection information D101.

The attack communication log record D432 is a record in which attack step: 3 is described, the access source host: the client terminal 121a is described, and for which “sign present” has been determined by the attack detection apparatus 102 based on the record 111 of the attack scenario detection information D101 in a similar manner.

The attack communication log record D433 is a record in which attack step: 4 is described, the access source host: the client terminal 121a is described, and for which “attacked” has been determined by the attack detection apparatus 102 based on the record 111 of the attack scenario detection information D101 in a similar manner.

In S102, the attacked terminal log information identification unit 113 retrieves attacked terminal log information associated with the attack communication log information D421.

First, the attacked terminal log information identification unit 113 receives the attack communication log information D421 from the receiving unit 111 (F102).

Then, the attacked terminal log information identification unit 113 transmits to the receiving unit 111 an attacked terminal log (process log) identifying request R101 (hereinafter also referred to just as a request R101) and an attacked terminal log (access log) identifying request R111 (hereinafter also referred to just as a request R111) in order to obtain the attacked terminal log information related to the attack communication log information D421 (F103).

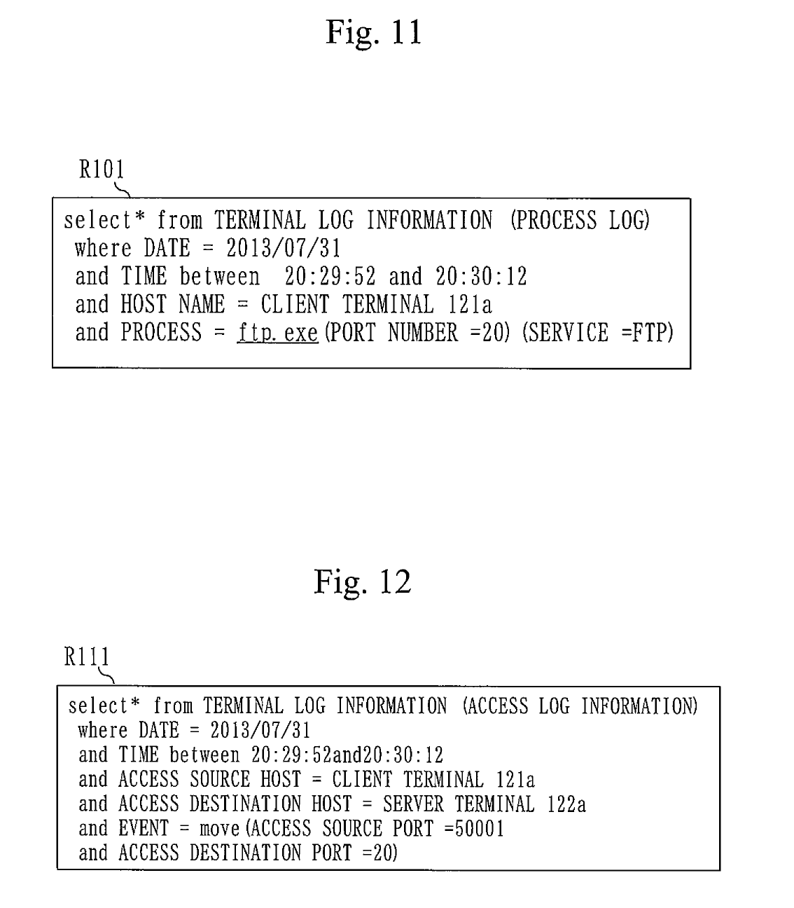

The attacked terminal log information identification unit 113 generates the request R101 illustrated in FIG. 11 and the request R111 illustrated in FIG. 12 from the attack communication log information D421, for example.

When communication port information is described in terminal log information (process log information) D201 (hereinafter also referred to just as a terminal log D201) in FIG. 5 and terminal log information (access log information) D301 (hereinafter also referred to just as a terminal log D301) in FIG. 7, the attacked terminal log information identification unit 113 may generate the request R101 and the request R111 associated with port numbers.

When the port numbers cannot be obtained from the terminal log information (process log information) D201 and the terminal log information (access log information) D301, however, the attacked terminal log information identification unit 113 generates the request R101 and the request R111 according to applications associated with the port numbers.

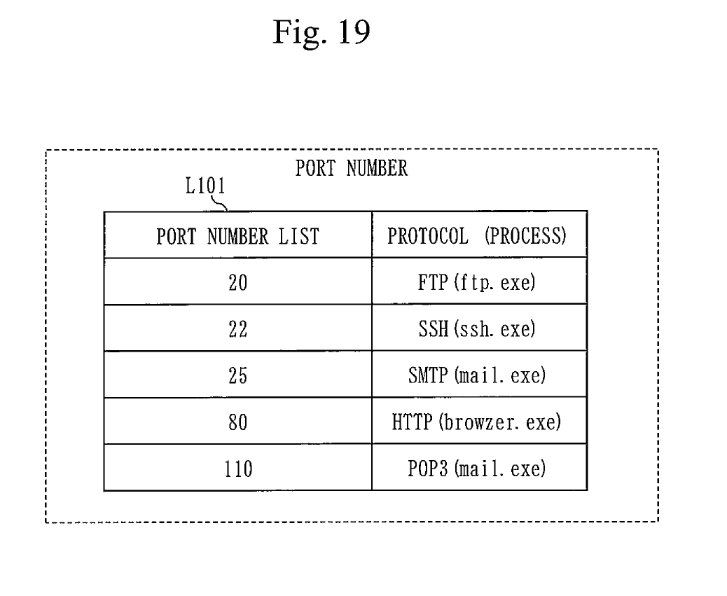

A correspondence between each port number and an application is made in a port number list L101 in FIG. 19, for example.

The access destination port of the attack communication log record D433 (FIG. 10) is 20, and a process to be accessed by using the number 20 is the “process=ftp. exe” according to the port number list L101 (FIG. 19). Thus, an attacked terminal log (process log) record associated with the attack communication log record D433 is D233 (FIG. 6).

It is considered that a file has been transferred when the communication port is used. Thus, due to “event=move”, an attacked terminal log (access log) record associated with the attack communication log record D433 is D333 (FIG. 8).

When a service is described in each of the terminal logs D201 and D301, the attacked terminal log information identification unit 113 should generate a request associated with the service described in the attack communication log D421 (FIG. 10).

The requests R101 and R111 are each a retrieval command in which a retrieval condition for retrieving the attacked terminal log information related to the attack communication log information D421 is described.

Details of the requests R101 and R111 will be described later.

The receiving unit 111 receives the requests R101 and R111 from the attacked terminal log information identification unit 113 (F103), and the receiving unit 111 transmits the requests R101 and R111 to the data processing system 106 (F104).

The data processing system 106 receives the requests R101 and R111 from the receiving unit 111 (F104), and retrieves the terminal log information that matches the request R101 and the terminal log information that matches the request R111 from the terminal log information (process log information) D201 and the terminal log information (access log information) D301.

When the data processing system 106 could retrieve the terminal log information that matched the request R101 and the terminal log information that matched the request R111, the data processing system 106 transmits the attacked terminal log information D221 and the attacked terminal log information D321 (FIGS. 6 and 8), which are results of the retrievals, to the receiving unit 111 (F105).

When the receiving unit 111 receives the attacked terminal log information D221 and the attacked terminal log information D321 from the data processing system 106, the receiving unit 111 transmits the attacked terminal log information D221 and the attacked terminal log information D321 to the attacked terminal log information identification unit 113 (F106).

When the attacked terminal log information identification unit 113 receives the attacked terminal log information D221 and the attacked terminal log information D321 from the receiving unit 111, the attacked terminal log information identification unit 113 transmits the attack communication log information D421 and the attacked terminal log information D221 and the attacked terminal log information D321 to the terminal log information falsification detection unit 114 (F107).

When the terminal log information that matches the request R101 and the terminal log information that matches the request R111 are not retrieved in the data processing system 106, a message indicating a “retrieval mishit” is transmitted from the data processing system 106 to the receiving unit 111, and is transferred from the receiving unit 111 to the attacked terminal log information identification unit 113.

Herein, a description will be directed to the request R101.

The retrieval condition about a date, a time, a host name, a process name (port number), and so on is included in the request R101, as illustrated in FIG. 11.

The attacked terminal log information identification unit 113 includes the retrieval condition of “date=2013/07/31” and “time between 20:29:52 and 20:30:12” in the request R101, based on the date and time of “2013/07/31 20:30:02” of the attack communication log record D433.

Since the device that obtains communication log information and the device that obtains terminal log information are different, a temporal deviation may occur between a time when the communication log information is obtained and a time when the terminal log information is obtained.

Then, the attacked terminal log information identification unit 113 determines the retrieval condition about the date and the time so that such an allowable error (10 seconds in the example of FIG. 11) may be absorbed.

To take an example, the time in an attacked terminal log record D213 in FIG. 6 is within the range of the allowable error. Thus, the attacked terminal log record D213 is extracted as the attacked terminal log information (process log information) D221.

Similarly, the time in an attacked terminal log record D313 in FIG. 7 is also within the range of the allowable error. Thus, the attacked terminal log record D313 is extracted as the attacked terminal log information (access log information) D321.

The attacked terminal log information identification unit 113 includes, in the request R101, “process=ftp. exe” and the retrieval condition of “host name=client terminal 121a” and the port number of “20”, from which the “client terminal 121a” being the ID (Identifier) of the access source host of the attack communication log record D433 is identified.

The “process=ftp. exe” is obtained from “FTP”, which is a process associated with the port number 20, according to the port number list L101 (FIG. 19).

A description will be directed to the request R111.

The retrieval condition about a date, a time, an access source host name, an access destination host name, and so on is included in the request R111, as illustrated in FIG. 12.

The date and the time are the same as those in the request R101.

With respect to an access source host, the attacked terminal log information identification unit 113 includes, in the request R101, “client terminal 121a” being the ID of the access source host in the communication log record D433 (FIG. 10), as the retrieval condition. With respect to an access destination host, the attacked terminal log information identification unit 113 includes, in the request R101, “server 122a” being the ID of the access destination host in the communication log record D433 (FIG. 10), as the retrieval condition.

Subsequently, in S103, the terminal log information falsification detection unit 114 determines whether or not the terminal log information is falsified.

That is, the terminal log information falsification detection unit 114 receives, from the attacked terminal log information identification unit 113, the attack communication log information D421, the attacked terminal log information D221, and the attacked terminal log information D321, or the message indicating the “retrieval mishit” (F107).

If the terminal log information falsification detection unit 114 has received the attacked terminal log information D221 and the attacked terminal log information D321, the terminal log information falsification detection unit 114 determines that there is no falsification in the terminal log information.

On the other hand, if the terminal log information falsification detection unit 114 has received the message indicating the “retrieval mishit”, the terminal log information falsification unit 114 determines that the terminal log information is falsified.

More specifically, the terminal log information falsification detection unit 114 determines that the terminal log information of the terminal (client terminal 121a in the example of FIG. 10) described in the attack communication log information D421 is falsified and determines that this terminal is infected with malware.

Herein, since the attacked terminal log associated with the attack communication log is detected, the client terminal 121a is regarded not to be falsified.

If the terminal log information is not falsified, the terminal log information falsification detection unit 114 informs to the attack user identification unit 115 that the terminal log is not falsified (F108).

On the other hand, if the terminal log information is falsified, the terminal log information falsification detection unit 114 informs to the infection activity identification unit 116 that there has been a falsification (F117).

If the terminal log information is not falsified (NO in S103), the attack user identification unit 115 identifies an attack user in S104.

First, the attack user identification unit 115 receives from the terminal log information falsification detection unit 114 the attacked terminal log information D221, the attacked terminal log information D321, and a message informing that the terminal log information is not falsified (F108), and identifies the attack user, using the attacked terminal log information D221 and the attacked terminal log information D321.

Then, the attack user identification unit 115 extracts the attack user involved in all the attack steps, and identifies the attack user who has carried out the attack detected by the attack detection apparatus 102.

The attack user identification unit 115 transmits to the infection activity identification unit 116 attack user information indicating the attack user identified (F109).

On the other hand, if the terminal log information is falsified (YES in S103), the attack user cannot be identified. Thus, identification of the attack user (S104) is not performed, and identification of an infection activity is performed (S105).

If the attack terminal log records D233 and D333 related to the attack communication log record D433 are not present, the log has been falsified. Thus, the attack user cannot be identified.

Then, the infection activity identification unit 116 detects an access from the terminal whose terminal log has been falsified to a different terminal in the communication log information D401 (FIG. 9) after attack step 3, and determines the terminal accessed as the terminal that may be infected with the malware.

In this example, the infection activity identification unit 116 transmits a request R221 in FIG. 22 from the receiving unit 111 to the communication log recording apparatus 104, and obtains from the communication log recording apparatus 104 the communication log 401 that is necessary, thereby allowing identification of the infection activity to the different terminal.

Even if there is no log falsification, the infection activity identification unit 116 identifies the infection activity to the different terminal in S105.

If there is no log falsification, the infection activity identification unit 116 first receives the attack user information from the attack user identification unit 115 (F109).

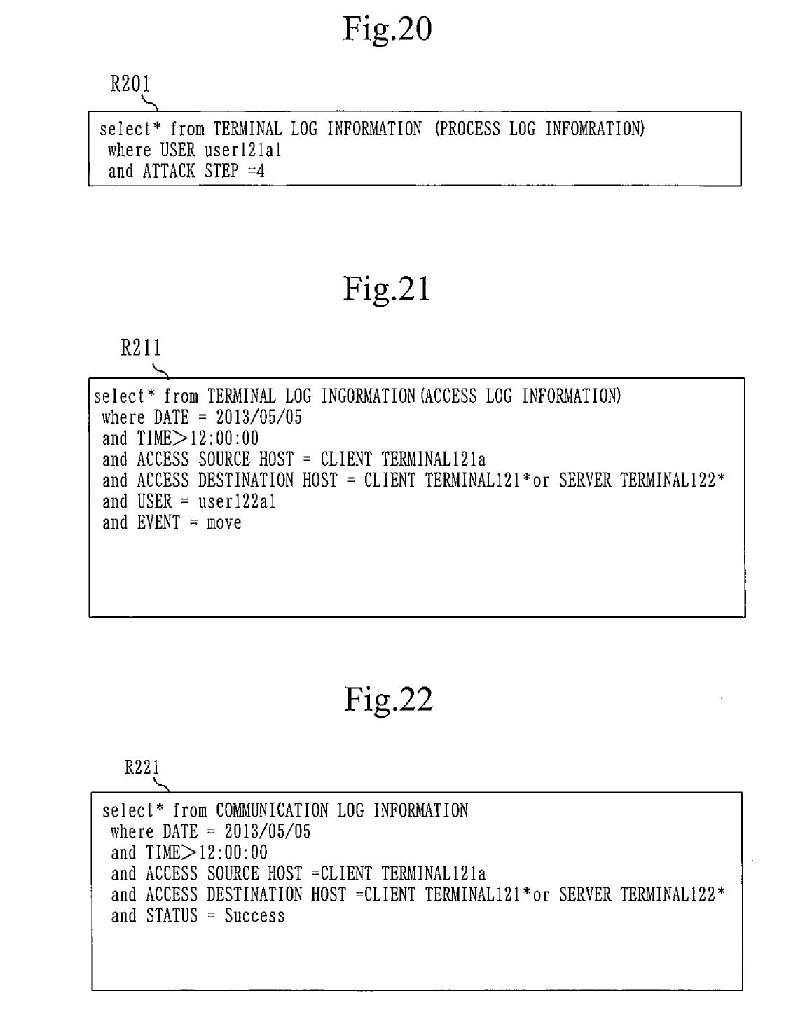

The infection activity identification unit 116 transmits requests R201 and R211 (FIGS. 20 and 21) to the receiving unit 111 in order to obtain infection activity terminal log information (malware transfer) related to the infection activity of the attack user (F110).

The receiving unit 111 receives the requests R201 and R211 from the infection activity identification unit 116 (F110), and transmits the requests R201 and R211 to the data processing system 106 (F111).

The data processing system 106 receives the requests R201 and R211 (F111), and transmits to the receiving unit the infection activity terminal log information corresponding to the requests R201 and R211 from the terminal log information (F112).

The receiving unit 111 receives the attacked terminal log information from the data processing system 106 (F112), and transmits the attacked terminal log information received to the infection activity identification unit 116 (F113).

Now, the request R201 and the request R211 will be described. Each of the request R201 and the request R211 is a request for identifying the infection activity from the infected terminal to the different terminal from among the terminal log information.

The request R201 is a request for identifying execution of attack step 4 by the attack user from among the terminal log information (process log information) D201 (FIG. 5).

Since attack step 4 is an attack step related to the infection activity to the different terminal, the infection activity identification unit 116 identifies the infection activity by identifying whether the attack user is performing attack step 4.

A terminal log information (process log information) record D214 (FIG. 5) is identified by the request R201.

The terminal log information (process log information) record D214 identified is registered in the infection activity terminal log information (process log information) D241 (FIG. 16).

The request R211 is a request for identifying an access of the infected terminal to the different terminal after attack step 3 from among the terminal log information (access log information) D301 (FIG. 7).

The log of attack step 3 in the attacked terminal log (access log information) D321 (FIG. 8) is a record D332. Thus, the infection activity identification unit 116 searches for the terminal in the data processing system 106, to which a file has been transmitted (moved) from a user 122a1 after “2013/05/05 12:00:00”. The user 122a1 is the attack user of the client terminal 121a that is the infected terminal.

The terminal log information (access log information) record D313 (FIG. 7) and a terminal log information (access log information) record D314 (FIG. 7) are identified by the request R211.

This makes the infection activity identification unit 116 to identify transmission of the malware to the server terminal 122a by the user 122a1 who is the attack user of the client terminal 121a.

The server terminal 122a is very likely to be infected with the malware.

The terminal log information (access log information) records D313 and D314 identified are registered in the infection activity terminal log information (access log information) D341 (FIG. 17).

On the other hand, if the log has been falsified, the terminal log information cannot be used. Thus, the infection activity identification unit 116 uses the communication log information (FIG. 9) to identify the infection range.

First, the infection activity identification unit 116 receives from the terminal log information falsification detection unit 114 information indicating that there is the falsification (F117).

The infection activity identification unit 116 transmits the request R221 to the receiving unit 111 in order to obtain infection activity communication log information (malware transfer) (F110).

The receiving unit 111 receives the request R221 from the infection activity identification unit 116 (F110), and transmits the request R221 to the attack detection apparatus 102 (F118).

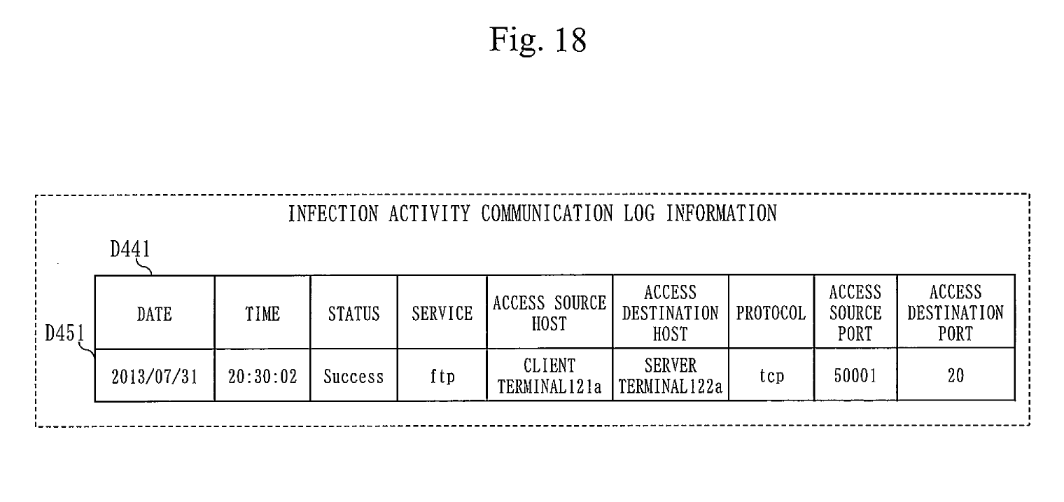

The attack detection apparatus 102 receives the request R221 (F118), retrieves infection activity communication log information D441 (FIG. 18) corresponding to the request R221 from the communication log information in the communication log recording apparatus 104. The attack detection apparatus 102 transmits to the receiving unit 111 (F119) the infection activity communication log information D441 (FIG. 18) retrieved.

The receiving unit 111 receives the infection activity communication log information D441 (FIG. 18) from the attack detection apparatus 102 (F119), and transmits to the infection activity identification unit 116 the infection activity communication log information D441 (FIG. 18) received (F113).

Now, a description will be given about the request R221.

The request R221 is a request for identifying the infection activity from the infected terminal to a different terminal from among the communication log information (FIG. 9).

The request R221 is a request for identifying an access from the infected terminal to the different terminal after attack step 3.

The log of attack step 3 in the attack communication log information (FIG. 10) is the record D432. Thus, the infection activity identification unit 116 searches for the terminal in the data processing system 106 accessed after “2013/05/05 12:00:00” from the client terminal 121a that is the infected terminal.

A record D414 in the communication log information (FIG. 9) is identified by the request R221.

This makes the infection activity identification unit 116 to identify that the malware may have been transmitted from the client terminal 121a to the server terminal 122a.

The server terminal 122a is very likely to be infected with the malware.

The record D414 of the communication log information identified is registered in the infection activity log information D441 (FIG. 18).

Assume that the infection activity identification unit 116 has detected the infection activity to the different terminal (YES in S106). Then, if the log has not been falsified, the infection activity identification unit 116 transmits the infection activity terminal log information D241 and the infection activity terminal log information D341 received in S105 to the attacked terminal log information identification unit 113 (F114). If the log has been falsified, the infection activity identification unit 116 transmits the infection activity communication log information D441 received in S105 to the attacked terminal log information identification unit 113 (F114).

Then, if the attacked terminal log information identification unit 113 receives the infection activity terminal log information D241 and the infection activity terminal log information D341, or the infection activity communication log information D441 from the infection activity identification unit 116 (F114), the attacked terminal log information identification unit 113 repeats the processes after step S102 with respect to the terminal log information on the terminal of an infection activity destination (server terminal 122a in the case of infection activity terminal log information (access log information) D351).

That is, retrieval of the terminal log information by the attacked terminal log information identification unit 113 and identification of the terminal that may be infected with the malware by the infection activity identification unit 16 are repeated.

In S102, the attacked terminal log information identification unit 113 identifies the attacked terminal log information D221 and the attacked terminal log information D321 from the attack communication log information D421. The infection activity terminal log information D241 and the infection activity terminal log information D341 and the infection activity communication log information D441 identified in S106 correspond to an attack in the step of initial intrusion (where the malware has been transmitted) for the terminal of the infection activity destination.

For this reason, the attacked terminal log information identification unit 113 adds a label of attack step 2 to each of the attacked terminal log information D221 and the attacked terminal log information D321 and the attack communication log information D421, and adds, to the attacked terminal log information D221 and the attacked terminal log information D321 and the attack communication log information D421, records of the infection activity terminal log information D241 and the infection activity terminal log information D341 and the attack communication log information D441 with labels added thereto.

On the other hand, if the infection activity identification unit 116 does not detect the infection activity to the different terminal (NO in step S106), the infection activity identification unit 116 registers in terminal infection information D501 (FIG. 13) a record related to the infected terminal discovered so far.

To take an example, the infection activity identification unit 116 registers terminal infection records D511 to D516 in the terminal infection information D501.

Then, the infection activity identification unit 116 transmits the terminal infection information D501 to the transmitting unit 112 (F115).

When the transmitting unit 112 receives the terminal infection information D501 from the infection activity identification unit 116 (F115), the transmitting unit 112 transmits the terminal infection information D501 to the monitoring apparatus 107.

When the monitoring apparatus 107 receives the terminal infection information D501 from the transmitting unit 112, the monitoring apparatus 107 displays the terminal infection information D501 on a display.

This allows the network security manager to confirm that the client terminals 121a, 122b, 121d, and the server terminal 122a are infected with the malware.

As described above, in this embodiment, the terminal log information falsification detection unit 114 determines whether the terminal log information has been fraudulently falsified, using the attack communication log information, so that an activity of an attacker to conceal the attack may be detected.

Then, by detecting the falsification of the terminal log information, the infection range of malware may be identified by a method other than analysis of the log information.

In this embodiment, the actions after intrusion of the attacker into the terminal is tracked using the logs, which is useful for identification of the infection range of malware referred to as a RAT (Remote Administration Tool), for example.

In this embodiment, the terminal log information may be held for each terminal. Thus, it is not necessary to periodically upload the log information from the terminal to a log server, so that traffic within the data processing system may be reduced.

Further, since an operation within the terminal is not constantly monitored, a user does not feel mental stress.

Further, by identifying an attack user, a sequence of contents of an attack by the attack user may be grasped.

Even if the log which is similar to the attack, such as transfer of an execution file, has been identified, this log is not related to the attack unless the user of the log is the attack user. Thus, a false alarm may be reduced.

The attacked terminal log information identification unit 113 may associate the terminal log information (process log information) with the terminal log information (access log information) information by adding information on a file which has accessed to each of the terminal log information (process log information) and the terminal log information (access log information).

Alternatively, the attacked terminal log information identification unit 113 may associate the terminal log information (process log information) with the terminal log information (access log information) by adding a process ID to each of the terminal log information (process log information) and the terminal log information (access log information).

Alternatively, even if information cannot be added to each of the terminal log information (process log information) and the terminal log information (access log information), the attacked terminal log information identification unit 113 may infer the terminal log information (process log information) and the terminal log information (access log information) which are corresponding to each other, based on the process in the terminal log information (process log information) and the accessed file and the event in the terminal log information (access log information).

By the abovementioned association between the terminal log information (process log information) and the terminal log information (access log information), the attacked terminal log information and infected terminal log information may be obtained just by a request related to the terminal log information (process log information) or a request related to the terminal log information (access log information).

The access source host and the access destination host described in each of the attack communication log information and the terminal log information may be respectively defined by an access source IP (Internet Protocol) address and an access destination IP address.

Even if the communication log information records the host names and the terminal log information records the IP addresses, the attacked terminal log information identification unit 113 may associate the attack communication log information with the terminal log information by using a correspondence table between the host names and the IP addresses.

Further, the attacked terminal log information identification unit 113 may associate the attack communication log information with the terminal log information by using a correspondence table recorded in a DNS (Domain Name System) server, an authentication server, or the like.

In a network using a DHCP (Dynamic Host Configuration Protocol), the attacked terminal log information identification unit 113 may associate the attack communication log information with the terminal log information by adding MAC (Media Access Control) addresses to each of the communication log information and the terminal log information.

The attack user identification unit 115 may identify an attack user who has been involved in a key attack step rather than all of the attack steps.

To take an example, a method may be conceived in which the attack steps are weighted and a user who has been involved in an attack with a certain threshold value or more is regarded as the attack user.

To take an example, assume a case where the weight of attack step 2 is set to 1, the weight of attack step 3 is set to 3, the weight of attack step 4 is set to 5, and the threshold value is set to 6 or more. Then, if a certain user has been involved in attack step 2 and attack step 4, the weights of the attack steps become 6. The user is therefore determined to be the attack user.

The attack user identification unit 115 may identify account switching of a user to a different user (such as logging-in with a different account using an su command or the like during the logging-in), and may identify an attack user group in consideration of a relationship of the accounts used between the users.

In attack step 3 and attack step 4, the attack user identification unit 115 may monitor an action of obtaining a different user account such as password exploitation or password hash acquisition using a brute force to identify an attack user group.

The attack user identification unit 115 may identify an attack user by identifying a user who performs an activity different from a common user, such as downloading of a plurality of files or frequent accesses to a different terminal in attack step 3 and attack step 4.

The infection activity identification unit 116 may identify an infection activity to a different terminal by an attack user identified by the attack user identification unit 115, such as execution of a file at the different terminal, remote access to the different terminal and downloading of a file at the different terminal, or the like.

### Embodiment 2

In the above-mentioned Embodiment 1, each client terminal 121 and each server terminal 122 respectively hold the client terminal log recording apparatus 131 and the server terminal log recording apparatus 132.

It may be so arranged that, instead of the above, a log server (processing log information server apparatus) is provided within the data processing system 106, and that each client terminal 121 and each server terminal 122 upload respective pieces of terminal log information to the log server.

That is, it may be so arranged that the client terminal log recording apparatus 131 and the server terminal log recording apparatus 132 respectively held by each client terminal 121 and each server terminal 122 are integrated into the log server.

By providing the log server, the terminal log information may be unitarily managed, and maintenance and use of the terminal log information may be facilitated.

The infection range identification apparatus 101 does not need to obtain the terminal log information from the client terminal log recording apparatus 131 or the server terminal log recording apparatus 132 of each terminal, and may just obtain the terminal log information from the log server alone.

### Embodiment 3

In the above-mentioned Embodiment 2, a configuration has been indicated where the client terminal log recording apparatus 131 and the server terminal log recording apparatus 132 respectively held by each client terminal 121 and each server terminal 122 are integrated into the log server.

Instead of the above, the infection range identification apparatus 101 may hold the client terminal log recording apparatus 131 and the server terminal log recording apparatus 132.

That is, it may be so arranged that a storage region (processing log information storage unit) that stores the terminal log information of each client terminal 121 and each server terminal 122 is provided for the infection range identification apparatus 101.

This facilitates acquisition of the terminal log information by the infection range identification apparatus 101.

### Embodiment 4

Referring to FIG. 1, the infection range identification apparatus 101, the attack detection apparatus 102, and the monitoring apparatus 107 are provided as separate apparatuses.

Instead of the above, the attack detection apparatus 102 and the monitoring apparatus 107 may be included in the infection range identification apparatus 101.

That is, an attack detection unit having the same function as the attack detection apparatus 102 is provided at the infection range identification apparatus 101, and a monitoring unit having the same function as the monitoring apparatus 107 may be included in the infection range monitoring apparatus 101.

By integrating a function of the infection range identification apparatus 101, the function of the attack detection apparatus 102, and the function of the monitoring apparatus 107 into one, transfer of data may be facilitated.

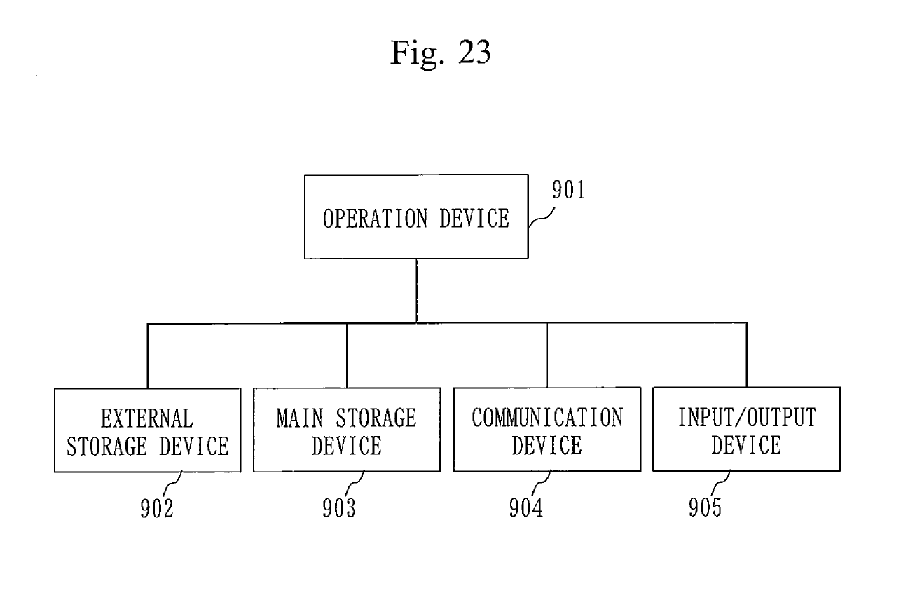

Finally, a hardware configuration example of the infection range identification apparatus 101 illustrated in Embodiments 1 to 4 will be described, with reference to FIG. 23.

The infection range identification apparatus 101 is a computer, and each element of the infection range identification apparatus 101 may be implemented by a program.

As the hardware configuration of the infection range identification apparatus 101, an operation device 901, an external storage device 902, a main storage device 903, a communication device 904, and an input/output device 905 are connected to a bus.

The operation device 901 is a CPU (Central Processing Unit) that implements programs.

The external storage device 902 is a ROM (Read Only Memory), a flash memory, or a hard disk drive, for example.

The main storage device 903 is a RAM (Random Access Memory).

The communication device 904 corresponds to the physical layer of the receiving unit 111 and the transmitting unit 112.

The input/output device 905 is a mouse, a keyboard, a display device, or the like, for example.

The programs are usually stored in the external storage device 902, and are sequentially read into and executed by the operation device 901, after having been loaded into the main storage device 903.

The programs are the ones that implement functions described as “˜units” illustrated in FIG. 1.

Further, an operating system (OS) is also stored in the external storage device 902, and at least a part of the OS is loaded into the main storage device 903. The operation device 901 executes the program that implements the function of each “˜unit” illustrated in FIG. 1, while executing the OS.

In the explanation of Embodiments 1 to 4, information, data, signal values, and variable values indicating results of processings described as “determination of ˜”, “judgment of ˜”, “extraction of ˜”, “detection of ˜”, “detection of”, “setting of ˜”, “registration of ˜”, “selection of ˜”, “retrieval of”, “generation of ˜”, “receipt of ˜”, “transmission of”, etc. are stored in the main storage device 903, as files.

The configuration in FIG. 23 illustrates just the example of the hardware configuration of the infection range identification apparatus 101. The hardware configuration of the infection range identification apparatus 101 is not limited to the configuration described in FIG. 23, and a different configuration may be employed.

Each of the attack detection apparatus 102, the security device 103, the client terminal 121, and the server terminal 122 may also have the hardware configuration in FIG. 23, or may have a different hardware configuration.

An information processing method according to the present invention may be implemented by the procedure indicated in each of Embodiments 1 to 4.

### REFERENCE SIGNS LIST

101: infection range identification apparatus, 102: attack detection apparatus, 103: security device, 104: communication log recording apparatus, 106: data processing system, 107: monitoring apparatus, 108: switch, 109: Internet, 111: receiving unit, 112: transmitting unit, 113: attacked terminal log information identification unit, 114: terminal log information falsification detection unit, 115: attack user identification unit, 116: infection activity identification unit, 121: client terminal, 122: server terminal, 131: client terminal log recording apparatus, 132: server terminal log recording apparatus

1-14. (canceled)

15. An information processing apparatus comprising:
processing circuitry:
to receive, with respect to an attack data communication to attack a data processing system including a plurality of devices, as attack communication log information, communication log information indicating an association between a communication time of the attack data communication, an attack step indicating a progress degree of an attack, and an attack-involved device being one of the plurality of devices in the data processing system and having been involved in the attack data communication,
to search processing log information indicating, with respect to each of a plurality of pieces of data processing performed by the plurality of devices, an association between a processing time of each of the plurality of pieces of data processing, a data processing device being one of the plurality of devices in the data processing system and having performed the data processing, and a user of the data processing device, to obtain a retrieval result indicating an association of the attack step and the user associated with the data processing whose processing time matches the communication time within an allowable error range and whose data processing device is the same as the attack-involved device, the data processing being related to the attack data communication, and
to analyze the association between the attack step and the user indicated in the retrieval result, to identify an attack user who has performed the attack data communication.

16. The information processing apparatus according to claim 15,
wherein the processing circuitry receives, with respect to each of a plurality of attack data communications, as the attack communication log information, communication log information indicating an association between the communication time, the attack step, and the attack-involved device,
searches the processing log information with respect to each of the plurality of attack data communications, to obtain a retrieval result indicating a plurality of the attack steps in the plurality of attack data communications and indicating associations between the plurality of attack steps and users, and
analyzes associations between the plurality of the attack steps and the users indicated in retrieval result, to identify an attack user who has performed the plurality of attack data communications.

17. The information processing system according to claim 16,
wherein when the users associated with the plurality of the attack steps indicated in the retrieval result are all identical, the processing circuitry regards a corresponding user, as the attack user.

18. The information processing apparatus according to claim 16,
wherein the processing circuitry regards a user associated with an arbitrary one of the plurality of the attack steps indicated in the retrieval result, as the attack user.

19. The information processing apparatus according to claim 16,
wherein the processing circuitry totalizes, for each user indicated in the retrieval result, a weight provided for each attack step indicated in the retrieval result, and regards a user associated with one or more of the attack steps having a totalized weight value equal to or higher than a threshold value, as the attack user.

20. The information processing apparatus according to claim 15,
wherein the processing circuitry searches processing log information indicating, with respect to each of the plurality of pieces of data processing, an association between the processing time, the data processing device, the user of the data processing device, and an access destination device being in the data processing system and being accessed by the data processing, and obtains a retrieval result indicating the access destination device associated with the attack user, and
regards that the attack user has made the attack to the access destination device indicated in the retrieval result.

21. An information processing method comprising:
receiving, with respect to an attack data communication to attack a data processing system including a plurality of devices, as attack communication log information, communication log information indicating an association between a communication time of the attack data communication, an attack step indicating a progress degree of an attack, and an attack-involved device being one of the plurality of devices in the data processing system and having been involved in the attack data communication;
searching processing log information indicating, with respect to each of a plurality of pieces of data processing performed by the plurality of devices, an association between a processing time of each of the plurality of pieces of data processing, a data processing device being one of the plurality of devices in the data processing system and having performed the data processing, and a user of the data processing device, to obtain a retrieval result indicating an association of the attack step and the user associated with the data processing whose processing time matches the communication time within an allowable error range and whose data processing device is the same as the attack-involved device, the data processing being related to the attack data communication; and
analyzing the association between the attack step and the user indicated in the retrieval result to identify an attack user who has performed the attack data communication.

22. A non-transitory computer readable medium storing a program to cause a computer to execute:
receiving, with respect to an attack data communication to attack a data processing system including a plurality of devices, as attack communication log information, communication log information indicating an association between a communication time of the attack data communication, an attack step indicating a progress degree of an attack, and an attack-involved device being one of the plurality of devices in the data processing system and having been involved in the attack data communication;
searching processing log information indicating, with respect to each of a plurality of pieces of data processing performed by the plurality of devices, an association between a processing time of each of the plurality of pieces of data processing, a data processing device being one of the plurality of devices in the data processing system and having performed the data processing, and a user of the data processing device, to obtain a retrieval result indicating an association of the attack step and the user associated with the data processing whose processing time matches the communication time within an allowable error range and whose data processing device is the same as the attack-involved device, the data processing being related to the attack data communication; and
analyzing the association between the attack step and the user indicated in the retrieval result to identify an attack user who has performed the attack data communication.
